(19) United States
(12) Patent Application Publication
(10) Pub. No.: US 2025/0391980 A1
(43) Pub. Date: Dec. 25, 2025

(54) BATTERY CASE

(71) Applicant: Merry Electronics(Shenzhen) Co., Ltd., ShenZhen (CN)

(72) Inventors: Chuan Chen Tan, Taichung (TW); Feng-Ping Chang, Taichung (TW); Wei-Hao Tu, Taichung (TW)

(73) Assignee: Merry Electronics(Shenzhen) Co., Ltd., ShenZhen (CN)

(21) Appl. No.: 18/747,484

(22) Filed: Jun. 19, 2024

(51) Int. Cl. H01M 50/24; B62M 6/90; F16J 15/02; H01M 50/249; H01M 50/271

(52) U.S. Cl. CPC H01M 50/24; B62M 6/90; F16J 15/022; H01M 50/249; H01M 50/271; H01M 2220/20

(57) ABSTRACT

Disclosed is a battery case suitable for being disposed on an electric assist bicycle. The battery case includes a case body, a cover plate and an elastic member. The cover plate is connected to the opening of the case body to jointly form an accommodation chamber. The elastic member is arranged between the cover plate and the opening of the case body. The elastic member includes a waterproof structure. The waterproof structure is configured to block a gap between the case body and the cover plate to prevent external water from entering the accommodation chamber through the gap.

### BACKGROUND

### Technical Field

The present disclosure relates to a battery case, and in particular to a battery case suitable for being disposed on an electric assist bicycle.

### Description of Related Art

Electric assist bicycles are now more popular. Generally speaking, batteries of electric assist bicycles are loaded in a battery case. However, the battery case is always exposed to the outside. Temperature changes or external impacts may easily affect the sealing of the battery case. Water, moisture or dust may easily enter the battery case and affect the battery life.

Therefore, how to improve the sealing performance of the battery case is an important issue for practitioners in the art.

### SUMMARY

The present disclosure provides a battery case with good sealing performance.

A battery case of the present disclosure is suitable for being disposed on an electric assist bicycle. The battery case includes a case body, a cover plate and an elastic member. The cover plate is connected to the opening of the case body to jointly form an accommodation chamber. The elastic member is disposed between the cover plate and the opening of the case body. The elastic member includes a waterproof structure. The waterproof structure is disposed to block a gap between the case body and the cover plate to prevent external water from entering the accommodation chamber through the gap.

In an embodiment of the present disclosure, the waterproof structure includes a plurality of first shark fins and a plurality of second shark fins, each first shark fin has a first tip, each first tip is inclined toward a first direction, each second shark fin has a second tip, each second tip is inclined toward a second direction, and the first direction is opposite to the second direction.

In an embodiment of the present disclosure, the elastic member includes an annular groove. The annular groove has an inner concave surface and a first portion and a second portion located on opposite sides of the inner concave surface. The first shark fin is disposed on the first portion, and the second shark fin is disposed on the second portion.

In an embodiment of the present disclosure, the case body includes a first engaging structure disposed on the opening. The first engaging structure includes a first wall, a second wall and a third wall. The first wall is parallel with the third wall, and the second wall is perpendicular to the first wall and the third wall.

In an embodiment of the present disclosure, the first portion has a first side surface and a second side surface opposite to each other, the first side surface faces the second wall, and the first shark fin protrudes from the first side surface and is squeezed by the second wall.

In an embodiment of the present disclosure, the first shark fin is continuously surrounding the first side surface.

In an embodiment of the present disclosure, the cover plate includes a second engaging structure. The second engaging structure has a stop surface and includes a first step portion and a second step portion. The stop surface is parallel with and faces the first wall, the first step portion is connected between the stop surface and the second step portion, and the second step portion abuts against the inner concave surface.

In an embodiment of the present disclosure, the first step portion includes a first surface and a second surface, the second step portion includes a third surface and a fourth surface, the first surface and the third surface are parallel with the second wall and face the second wall, and the second surface and the fourth surface are parallel with the stop surface and face the third wall.

In an embodiment of the present disclosure, the second side surface abuts against and is parallel with the third surface.

In an embodiment of the present disclosure, the first portion has a first end surface and a second end surface opposite to each other. The first end surface abuts against and is parallel with the second surface, and the second end surface abuts against and is parallel with the third wall.

In an embodiment of the present disclosure, in an extending direction of the case body, a first distance between the second surface and the third wall is greater than a second distance between the fourth surface and the third wall.

In an embodiment of the present disclosure, the second step portion further includes a bottom surface, the bottom surface is connected to the fourth surface, and the second portion extends to the bottom surface.

In an embodiment of the present disclosure, the second portion has an inner side surface facing the bottom surface, and the second shark fin protrudes from the inner side surface and is squeezed by the bottom surface.

In an embodiment of the present disclosure, the second shark fin is continuously surrounding the inner side surface.

Based on the above, in the battery case of the present disclosure, an elastic member is disposed between the cover plate and the opening of the case body. The elastic member includes a waterproof structure protruding from the surface of the elastic member. The waterproof structure is disposed to block the gap between the case body and the cover plate to prevent external water from entering the accommodation chamber through the gap.

In order to make the features and advantages of the present disclosure more clear and easy to understand, embodiments are given below and described in detail with reference to the attached drawings.

### BRIEF DESCRIPTION OF THE DRAWINGS

FIG. 1 is a three-dimensional schematic view of a battery case according to an embodiment of the present disclosure.

FIG. 2 is a disassembly view of the battery case of FIG. 1.

FIG. 3A is a three-dimensional view of the elastic member of FIG. 2.

FIG. 3B is a partial cross-sectional enlarged view of the elastic member of FIG. 3A.

FIG. 4A is a schematic cross-sectional view of the battery case of FIG. 1.

FIG. 4B is a partial enlarged view of the battery case of FIG. 4A.

FIG. 4C is a schematic side view of the elastic member of FIG. 4B.

FIG. 5 is a schematic cross-sectional view of an elastic member according to an embodiment of the present disclosure.

### DESCRIPTION OF THE EMBODIMENTS

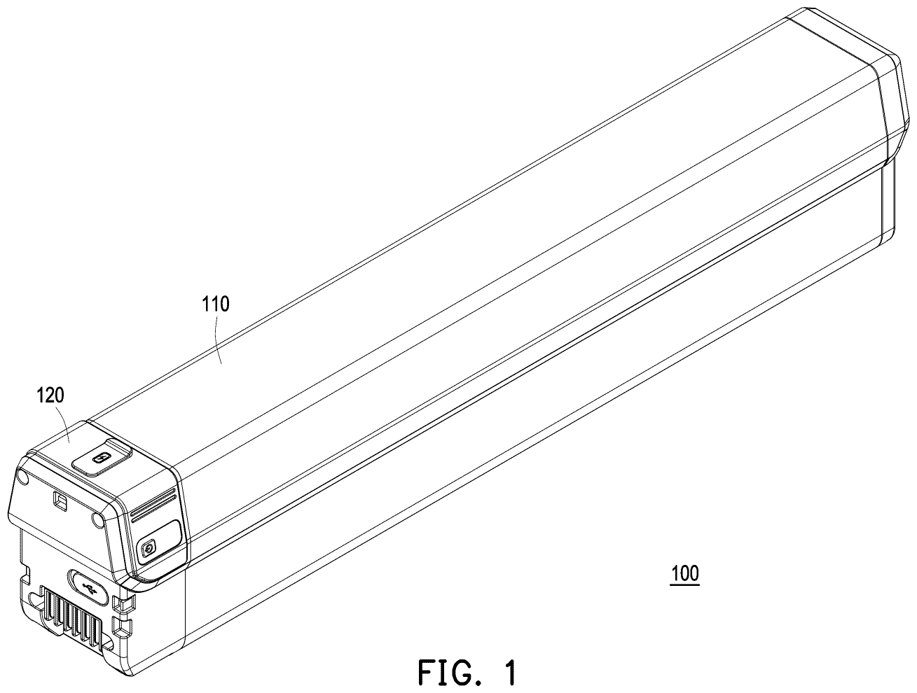

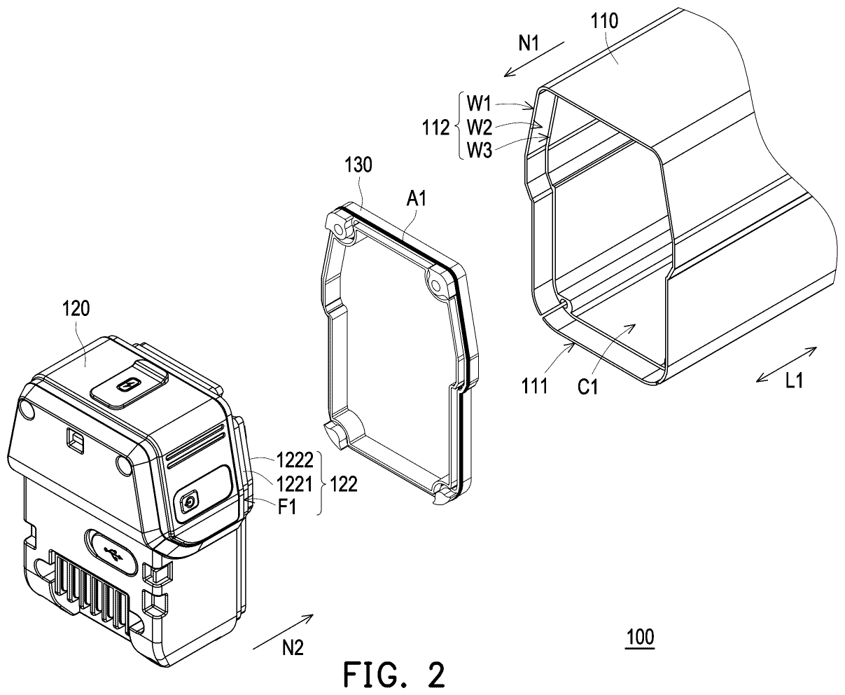

FIG. 1 is a three-dimensional schematic view of a battery case according to an embodiment of the present disclosure. FIG. 2 is a disassembly view of the battery case of FIG. 1. Please refer to FIG. 1 and FIG. 2. The battery case 100 of this embodiment is suitable for being disposed on an electric assist bicycle. The disclosure is not limited thereto. In this embodiment, the battery case 100 includes a case body 110, a cover plate 120 and an elastic member 130. The elastic member 130 is disposed between the cover plate 120 and the opening 111 of the case body 110. The cover plate 120 is connected to the opening 111 of the case body 110 to jointly form an accommodation chamber C1.

In this embodiment, the elastic member 130 is, for example, a rubber ring, provided to seal the accommodation chamber C1. In other embodiments, an elastic member falls within the scope to be protected by the present disclosure as long as the elastic member has a waterproof function and may be squeezed between the cover plate and the case body to improve sealing performance. The present disclosure is not limited thereto.

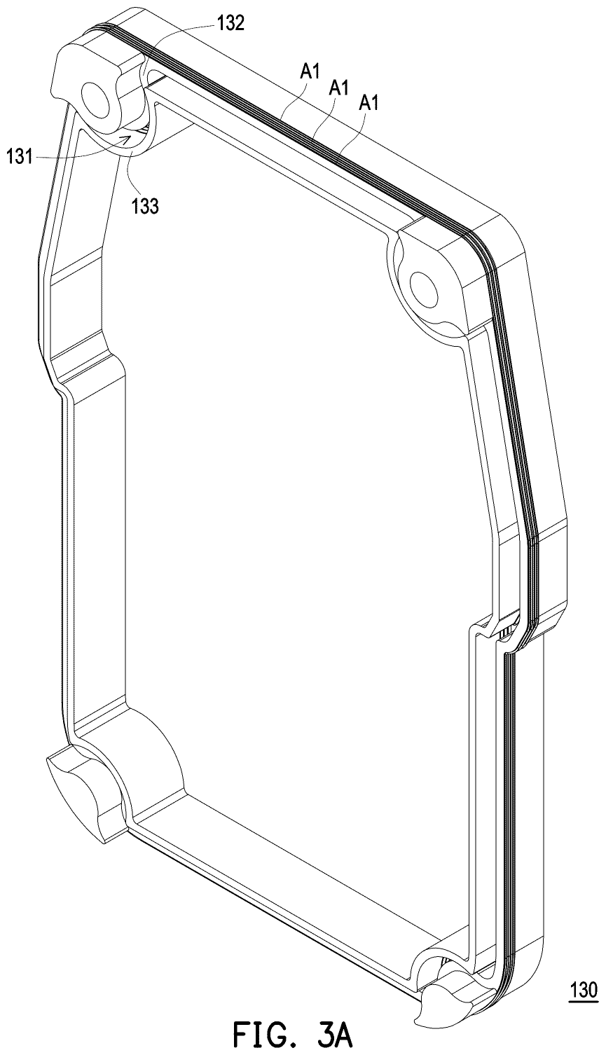

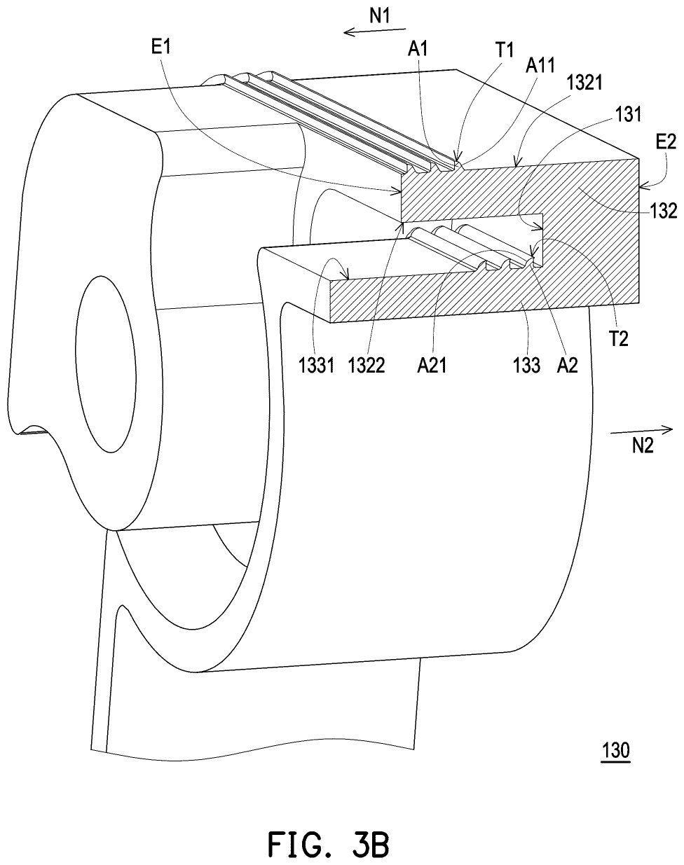

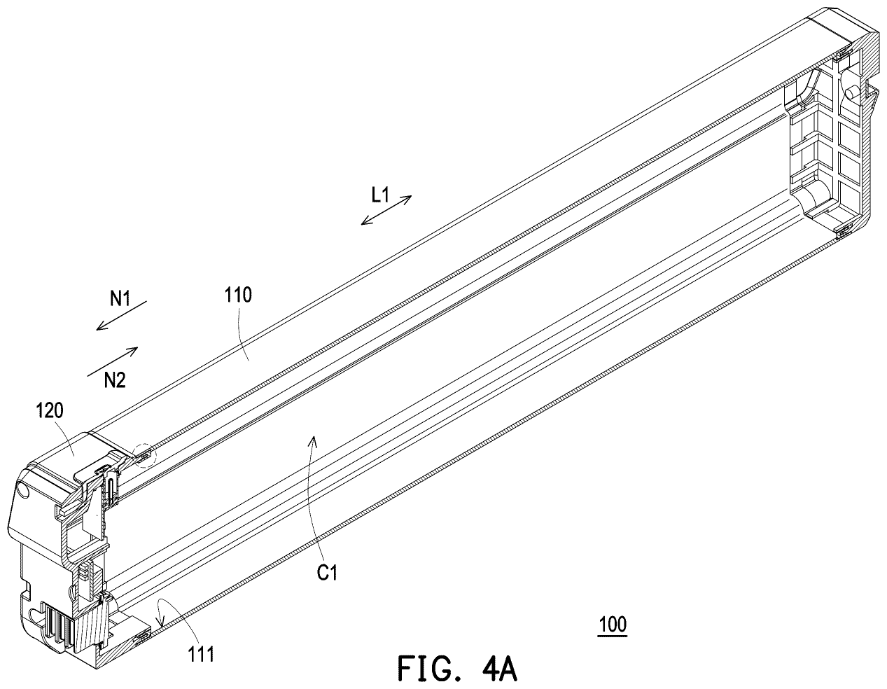

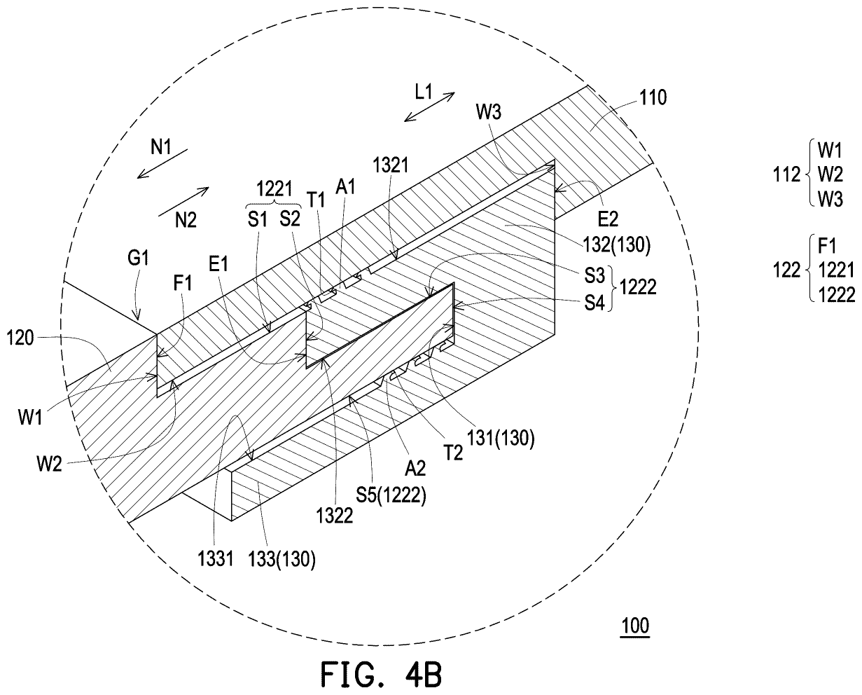

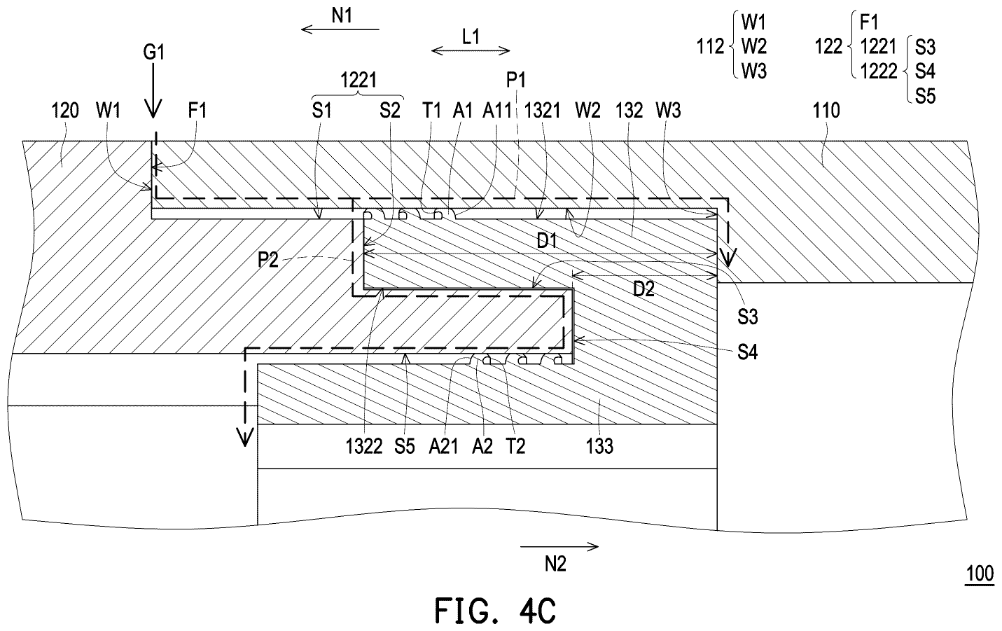

FIG. 3A is a three-dimensional view of the elastic member of FIG. 2. FIG. 3B is a partial cross-sectional enlarged view of the elastic member of FIG. 3A. FIG. 4A is a schematic cross-sectional view of the battery case of FIG. 1. FIG. 4B is a partial enlarged view of the battery case of FIG. 4A. FIG. 4C is a schematic side view of the elastic member of FIG. 4B. It should be noted that the dashed-line arrow in FIG. 4C only schematically depicts the water inlet path. The disclosure is not limited thereto.

Please refer to FIG. 3A and FIG. 3B. In this embodiment, the elastic member 130 includes a waterproof structure protruding from the surface of the elastic member 130. The waterproof structure is disposed to block the gap between the case body 110 and the cover plate 120 to prevent external water from entering the accommodation chamber C1 through the gap. In this embodiment, the waterproof structure includes a plurality of first shark fins A1 and a plurality of second shark fins A2, the shapes of which are similar to those of shark fins. The disclosure is not limited thereto.

In this embodiment, the elastic member 130 includes an annular groove, and the annular groove includes an inner concave surface 131 and a first portion 132 and a second portion 133 disposed on opposite sides of the inner concave surface 131. The first shark fin A1 is disposed on the first portion 132, and the second shark fin A2 is disposed on the second portion 133.

Viewing from the cross-sectional view of FIG. 4B, the first portion 132 is closer to the position G1 than the second portion 133. The first portion 132 and the second portion 133 of the elastic member 130 are connected to form a U shape. The disclosure is not limited thereto.

Please refer to FIG. 4C. With the above configuration, when external water permeates through the position G1, the first shark fin A1 is able to block the external water from entering the accommodation chamber C1 through the path P1. The second shark fin A2 is able to block external water from entering the accommodation chamber C1 through the path P2. In this way, the waterproof structure of the elastic member 130 may enhance the sealing between the cover plate 120 and the case body 110, so that the battery case 100 has a better waterproof effect.

In detail, please refer to FIG. 2. In this embodiment, the case body 110 includes a first engaging structure 112 disposed on the opening 111. The cover plate 120 includes a second engaging structure 122. The elastic member 130 is disposed between the first engaging structure 112 and the second engaging structure 122. The first engaging structure 112 and the second engaging structure 122 are adapted to engage with each other to tightly press the elastic member 130. In an embodiment, the elastic member 130 has an avoidance hole for fixing the cover plate 120 and the case body 110 through pins or concave and convex structures. The disclosure is not limited thereto.

Please refer to FIG. 4B. In this embodiment, the first engaging structure 112 of the case body 110 includes a first wall W1, a second wall W2 and a third wall W3. The first wall W1 is parallel with the third wall W3, and the second wall W2 is perpendicular to the first wall W1 and the third wall W3.

In this embodiment, the first portion 132 has a first side surface 1321 and a second side surface 1322 opposite to each other. The first side surface 1321 faces the second wall W2, and the first shark fin A1 protrudes from the first side surface 1321 and is squeezed by the second wall W2.

In this embodiment, the second engaging structure 122 of the cover plate 120 has a stop surface F1 and includes a first step portion 1221 and a second step portion 1222. The second step portion 1222 abuts against the inner concave surface 131 of the elastic member 130.

In this embodiment, the stop surface F1 is parallel with and faces the first wall W1, and the stop surface F1 abuts against the first wall W1. The first step portion 1221 is connected between the stop surface F1 and the second step portion 1222. Specifically, the stop surface F1 is perpendicular to an extending direction L1 of the case body 110.

In this embodiment, the first step portion 1221 includes a first surface S1 and a second surface S2, the second step portion 1222 includes a third surface S3 and a fourth surface S4. The first step portion 1221 is connected to the second step portion 1222 to form a step structure. Here, the fourth surface S4 of the second step portion 1222 abuts against the inner concave surface 131.

In this embodiment, the first surface S1 and the third surface S3 are parallel with the second wall W2 and face the second wall W2, and the second surface S2 and the fourth surface S4 are parallel with the stop surface F1 and face the third wall W3. Viewing from the cross-section of FIG. 4B, the first surface S1, the third surface S3 and the second wall W2 are parallel with the extending direction L1 of the case body 110, and the second surface S2, the fourth surface S4 and the third wall W3 are perpendicular to the extending direction L1 of the case body 110. The present disclosure is not limited thereto.

In this embodiment, the first portion 132 has a first end surface E1 and a second end surface E2 opposite to each other. The first end surface E1 is connected between the first side surface 1321 and the second side surface 1322. The first side surface 1321 is connected between the first end surface E1 and the second end surface E2. The first end surface E1 abuts against and is parallel with the second surface S2, and the second end surface E2 abuts against and is parallel with the third wall W3. The second side surface 1322 of the first portion 132 abuts against and is parallel with the third surface S3.

In this embodiment, the second step portion 1222 further includes a bottom surface S5. The bottom surface S5 is connected to the fourth surface S4, and the second portion 133 extends to the bottom surface S5. The second portion 133 has an inner side surface 1331 facing the bottom surface S5. The second shark fin A2 protrudes from the inner side surface 1331 and is squeezed by the bottom surface S5.

Please refer to FIG. 4C. In this embodiment, in the extending direction L1 of the case body 110, a first distance D1 between the second surface S2 and the third wall W3 is greater than a second distance D2 between the fourth surface S4 and the third wall W3.

In this embodiment, the number of the first shark fins A1 is three and they are arranged at equal intervals, and the number of the second shark fins A2 is three and they are arranged at equal intervals. In other embodiments, the number of shark fins may be increased or decreased according to the space of the product. The present disclosure is not limited thereto.

In this embodiment, the tip of the shark fin faces the water inlet direction, which may delay and lower the ascending of water. Specifically, each first shark fin A1 has a first tip T1, and each first tip T1 is inclined toward a first direction N1 to block water from permeating along the path P1. Each second shark fin A2 has a second tip T2, and each second tip T2 is inclined toward a second direction N2 to block water from permeating along the path P2. Here, the first direction N1 is opposite to the second direction N2. The present disclosure is not limited thereto.

In this way, when the case body 110 is assembled in a direction from right to left (that is, along the first direction N1), the first tip T1 of the first shark fin A1 faces the left, that is, toward the first direction N1. In other words, the first front fin surface A11 of the first shark fin A1 faces the right (away from the first direction N1). The advantage of such design is that when the case body 110 is abutted against and engaged with the elastic member 130 along the first direction N1, the first front fin surface A11 of the first shark fin A1 may abut against the second wall W2 of the case body 110 and is squeezed to bend, which facilitates assembly.

When the cover plate 120 is assembled in a direction from left to right (that is, along the second direction N2), the second tip T2 of the second shark fin A2 faces the right, that is, toward the second direction N2. In other words, the second front fin surface A21 of the second shark fin A2 faces the left (away from the second direction N2). The advantage of such design is that when the cover plate 120 is abutted against and engaged with the elastic member 130 along the second direction N2, the second front fin surface A21 of the second shark fin A2 may abut against the bottom surface S5 of the cover plate 120 and is squeezed to bend, which facilitates assembly. Other embodiments will be listed below as illustrations. It should be noted here that the following embodiments adopt the component numbers and part of the content of the previous embodiments, where the same numbers are used to represent the same or similar elements, and descriptions of the same technical content are omitted. For descriptions of omitted parts, reference may be made to the foregoing embodiments and will not be repeated in the following embodiments.

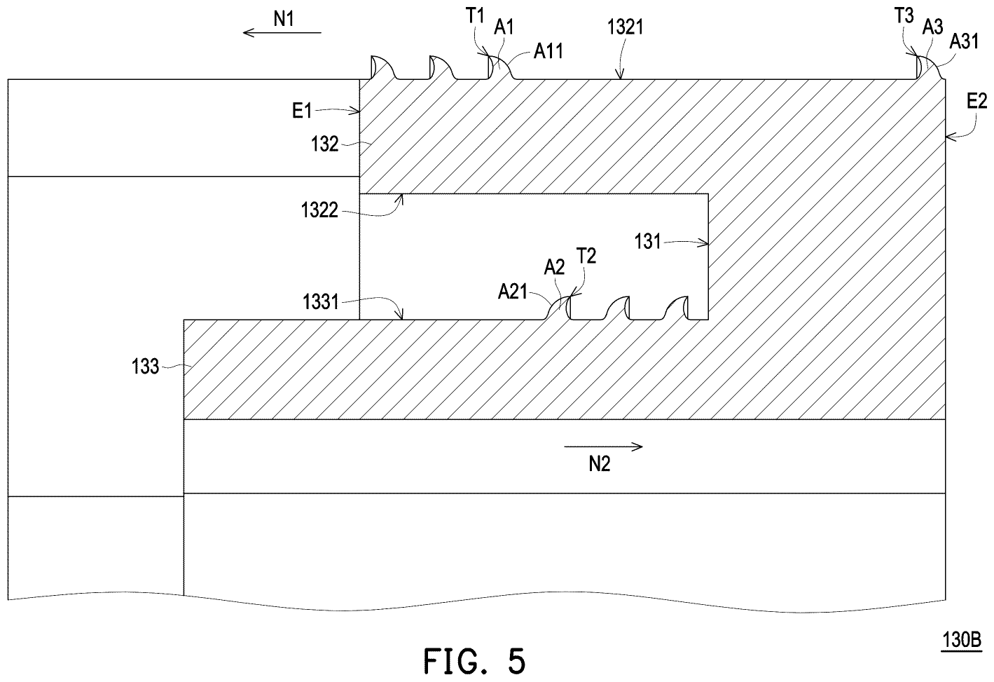

FIG. 5 is a schematic cross-sectional view of an elastic member according to an embodiment of the present disclosure. Please refer to FIG. 5. In this embodiment, the elastic member 130B is slightly different from the elastic member 130 in FIG. 3B. The main difference between them is that the waterproof structure of the elastic member 130B further includes a third shark fin A3.

In this embodiment, the third tip T3 of the third shark fin A3 is inclined toward the first direction N1, so that the water is not easy to ascend. Furthermore, the third shark fin A3 is closer to the second end face E2 than the first shark fin A1 to enhance the waterproof effect between the first portion 132 and the case body 110 of FIG. 4C, thereby preventing external water from entering the interior of the battery case through the path P1 shown in FIG. 4C. In other embodiments, if water permeates through other multiple paths, shark fins may be added to the paths to prevent water from permeating. The disclosure is not limited thereto.

To sum up, in the battery case of the present disclosure, an elastic member is disposed between the cover plate and the opening of the case body. The elastic member includes a plurality of shark fins protruding from the surface of the elastic member to block the gap between the case body and the cover plate to prevent external water from entering the accommodation chamber through the gap. Moreover, the tip of the shark fin faces the water inlet direction, which may delay and lower the ascending of water.

Although the present disclosure has been disclosed above through embodiments, it is not intended to limit the present disclosure. Anyone with ordinary knowledge in the technical field can make some modifications and refinement without departing from the spirit and scope of the present disclosure. Therefore, the scope to be protected by the present disclosure shall be determined by the appended claims.

What is claimed is:

1. A battery case, suitable for being disposed on an electric assist bicycle, the battery case comprising:
a case body;
a cover plate connected to an opening of the case body to jointly form an accommodation chamber; and
an elastic member disposed between the cover plate and the opening of the case body, wherein the elastic member comprises a waterproof structure, the waterproof structure is disposed to block a gap between the case body and the cover plate to prevent external water from entering the accommodation chamber through the gap.

2. The battery case according to claim 1, wherein the waterproof structure comprises a plurality of first shark fins and a plurality of second shark fins, each of the plurality of first shark fins has a first tip, each of the first tip is inclined toward a first direction, each of the plurality of second shark fins has a second tip, each of the second tip is inclined toward a second direction, and the first direction is opposite to the second direction.

3. The battery case according to claim 2, wherein the elastic member comprises an annular groove, the annular groove has an inner concave surface and a first portion and a second portion located on opposite sides of the inner concave surface, the plurality of first shark fins are disposed on the first portion, and the plurality of second shark fins are disposed on the second portion.

4. The battery case according claim 3, wherein the case body comprises a first engaging structure disposed on the opening, the first engaging structure comprises a first wall, a second wall and a third wall, the first wall is parallel with the third wall, and the second wall is perpendicular to the first wall and the third wall.

5. The battery case according to claim 4, wherein the first portion has a first side surface and a second side surface opposite to each other, the first side surface faces the second wall, and the plurality of first shark fins protrude from the first side surface and are squeezed by the second wall.

6. The battery case according to claim 5, wherein the plurality of first shark fins are continuously surrounding the first side surface.

7. The battery case according to claim 5, wherein the cover plate comprises a second engaging structure, the second engaging structure has a stop surface and comprises a first step portion and a second step portion, the stop surface is parallel with and faces the first wall, the first step portion is connected between the stop surface and the second step portion, and the second step portion abuts against the inner concave surface.

8. The battery case according to claim 7, wherein the first step portion comprises a first surface and a second surface, the second step portion comprises a third surface and a fourth surface, the first surface and the third surface are parallel with the second wall and face the second wall, and the second surface and the fourth surface are parallel with the stop surface and face the third wall.

9. The battery case according to claim 8, wherein the second side surface abuts against and is parallel with the third surface.

10. The battery case according to claim 8, wherein the first portion has a first end surface and a second end surface opposite to each other, the first end surface abuts against and is parallel with the second surface, and the second end surface abuts against and is parallel with the third wall.

11. The battery case according to claim 8, wherein in an extending direction of the case body, a first distance between the second surface and the third wall is greater than a second distance between the fourth surface and the third wall.

12. The battery case according to claim 8, wherein the second step portion further comprises a bottom surface, the bottom surface is connected to the fourth surface, and the second portion extends to the bottom surface.

13. The battery case according to claim 12, wherein the second portion has an inner side surface facing the bottom surface, and the plurality of second shark fins protrude from the inner side surface and are squeezed by the bottom surface.

14. The battery case according to claim 13, wherein the plurality of second shark fins are continuously surrounding the inner side surface.
